(19) United States
(12) Patent Application Publication
(10) Pub. No.: US 2014/0148236 A1
(43) Pub. Date: May 29, 2014

(54) GAMING SYSTEM SERVER

(71) Applicant: Aristocrat Technologies Australia PTY Limited, North Ryde (AU)

(72) Inventor: Sven Hakan Andersson, Sundbyberg (SE)

(73) Assignee: Aristocrat Technologies Australia PTY Limited, North Ryde (AU)

(21) Appl. No.: 14/168,713

(22) Filed: Jan. 30, 2014

Related U.S. Application Data
(63) Continuation of application No. 13/083,087, filed on Apr. 8, 2011, now abandoned.

(30) Foreign Application Priority Data
Apr. 20, 2010 (AU) 2010901658

(51) Int. Cl. G07F 17/32

(52) U.S. Cl. CPC G07F 17/329
USPC 463/17

(57) ABSTRACT

An example gaming system server is arranged to receive terminal data from a player operable terminal and determine whether the terminal data includes at least one of game play data and lottery data. The server includes a game module which operates in response to a determination that the terminal data includes game play data to generate server game data based on the game play data for transmission to the player operable terminal; a lottery module which operates in response to a determination that the terminal data includes lottery data to generate a lottery entry; and a communication module arranged to communicate the lottery entry to an independent lottery system in a form compatible with the lottery system, receive a receipt from the lottery system for the lottery entry, and associate the receipt with the terminal.

### CROSS REFERENCE TO RELATED APPLICATIONS

The present application relates to and claims the benefit of priority from U.S. patent application Ser. No. 13/083,087, filed on Apr. 8, 2011, entitled “GAMING SYSTEM SERVER,” which claims the benefit of priority to Australian Provisional Patent Application Number 2010901658, filed on Apr. 20, 2010, each of which is herein incorporated by reference in its entirety.

### FIELD

The present invention relates generally to a gaming system server.

### BACKGROUND

Currently, client/server gaming systems are proposed which enable clients to access games hosted by proprietary game servers.

### SUMMARY

Certain embodiments of the invention provide a gaming system server, the server arranged to receive terminal data from a player operable terminal and determine whether the terminal data includes at least one of game play data and lottery data, the server comprising:
a game module which operates in response to a determination that the terminal data includes game play data to generate server game data based on the game play data for transmission to the player operable terminal;
a lottery module which operates in response to a determination that the terminal data includes lottery data to generate a lottery entry; and
a communication module for communicating the lottery entry to an independent lottery system in a form compatible with the lottery system, receiving a receipt from the lottery system for the lottery entry, and associating the receipt with the terminal.

In an embodiment, the server associates the receipt with a terminal by associating the receipt with a player of the terminal.

In an embodiment, the gaming system server comprises a determination module for conducting the determination.

In an embodiment, the determination module selectively activates the lottery module or the game module in dependence on whether game play data or lottery data is included in the terminal data.

In an embodiment, the gaming system server is arranged to communicate with a plurality of player operable terminals and process terminal data from each player terminal to determine whether the terminal data includes game play data or lottery data.

In an embodiment, the server comprises a plurality of computers and the communication module is implemented by a computer which is separate to the computer or computers which implement the game play module and the lottery module.

In an embodiment, the gaming system server comprises a processor and a tangible memory accessible by the processor to enable the processor to execute computer program instructions stored therein for the game play module, the lottery module and the communications module.

Certain embodiments of the invention also provide a method in a gaming system, comprising:
receiving terminal data from a player operable terminal at a gaming server and determining whether the terminal data includes at least one of game play data and lottery data, the server comprising:
operating a game module of the game server in response to a determination that the terminal data includes game play data to generate server game data based on the game play data for transmission to the player operable terminal;
operating a lottery module of the game server in response to a determination that the terminal data includes lottery data to generate a lottery entry;
communicating the lottery entry from the game server to an independent lottery system in a form compatible with the lottery system;
receiving a receipt at the game server from the lottery system for the lottery entry; and
associating the receipt with the terminal.

In an embodiment, the method comprises associating the receipt with a terminal by associating the receipt with a player of the terminal.

In an embodiment, the method comprises selectively activating the lottery module or the game module in dependence on whether game play data or lottery data is included in the terminal data.

Certain embodiments of the invention also provide program code which when executed implements the method.

Certain embodiments of the invention also provide a tangible computer readable medium comprising the computer program code.

### BRIEF DESCRIPTION OF ACCOMPANYING DRAWINGS

Certain embodiments of the invention are further explained by means of the following non-limiting examples and in conjunction with the accompanying drawings, in which:

FIG. 1 shows schematically an embodiment of a client-server based gaming system with a plurality of gaming terminals in accordance with an embodiment of the invention;

FIG. 2 is a block diagram of further components of a gaming system; and

FIG. 3 is a functional block diagram of certain components of a gaming system.

The foregoing summary, as well as the following detailed description of certain embodiments of the present invention, will be better understood when read in conjunction with the drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EMBODIMENTS

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, at least one of the elements in an at least one example is hereby expressly defined to include a tangible medium such as a memory, DVD, CD, Blu-ray, etc. storing the software and/or firmware.

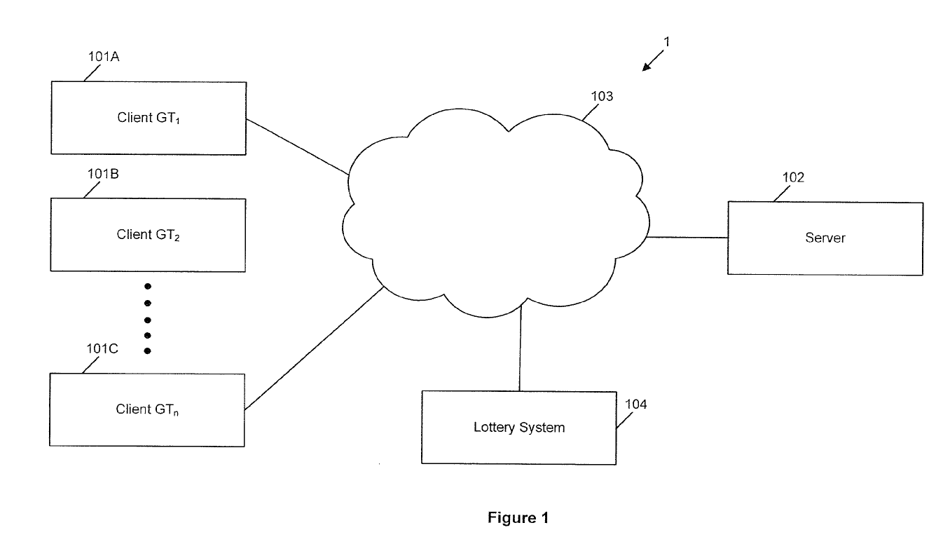

FIG. 1 shows schematically a gaming system 1 with a plurality of gaming terminals GT1, GT2 . . . GTn 101, where the number n is arbitrary. Each gaming terminal 101 is equipped with a player interface having a display screen and input means comprised of one or more input devices, such as a touch screen, and client game program code which implements a number of functions when executed as described in further detail below including communicating via a network, in the form of Internet 103, with a server 102 to seek to establish a gaming session with a game module on server 102. The server 102 is also arranged to communicate with an external lottery system 104 via the Internet 103.

The gaming system 1 according to the present embodiment is based on a client/server architecture where the game software is divided into a client game module and a server game module. In order to run a game the client game module is associated with, and use functions available at, a server game module. When a game is played via a client gaming terminal 101, a game session is established and game session data is generated in the course of the game. Each game session has a specific identity and is assigned a game session identify code. The game session data is stored in the game server database associated with the game session identity code.

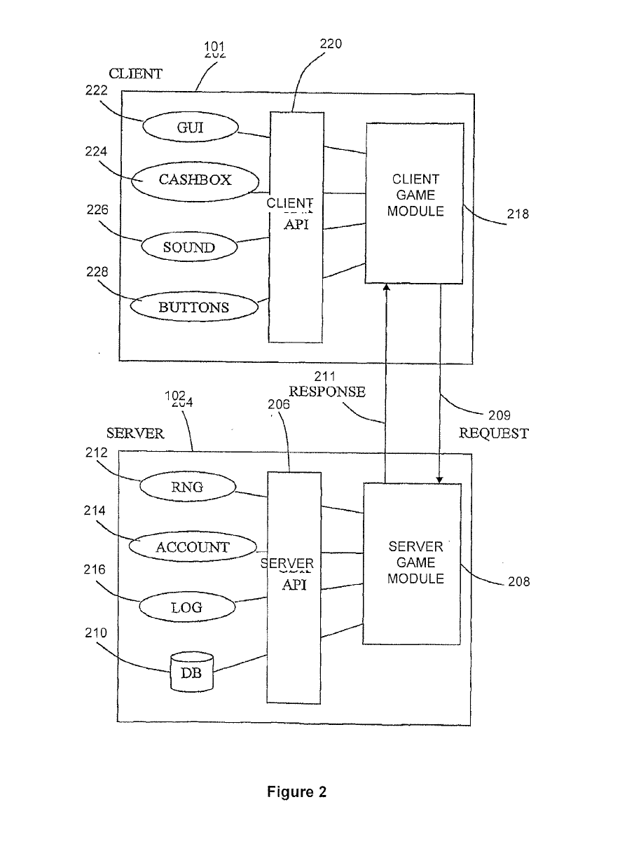

FIG. 2 shows schematically a client and server based computerised gaming system in further detail with a client gaming terminal 101 and a server 102 that are communicatively coupled. The gaming terminal 101 and the server 102 are provided with data processors, memory, data communications interfaces, control programs, user input/output interfaces etc as is known in the art. Different functions and features that are specific to an embodiment are preferably realised by software computer program code executed by data processors in the server and in the client respectively, or by employing specifically designed electronic components, or by means of combinations of software and electronic components. In the example of FIG. 2, there is only a single client gaming terminal 101 but of course a number of client gaming terminals 101 are normally connected to a server 102 as shown in FIG. 1. In this context a server 204 generally means hardware and software units in a central system that provide server functions, database functions and other centralized functions to connectable client gaming terminals 101.

The server 102 is provided with an application program interface, in short called server API 206, enabling communication between a server module of a specific game application program 208 and general server gaming functions 210,212,214,216 installed on the server 102. The general server gaming functions are provided to be available for any specific game application program independently of the specific game content. These general server gaming functions are typically functions such as a database 210, a random number generator 212, an account service function 214, a log service function 216, or other functions that can be beneficially shared and used by different specific game application programs.

The client gaming terminal 101 is also provided with an application program interface, “client API” 220, enabling communication between a client game module 218 of the specific game application program and general client gaming functions 222,224,226,228 installed on the client gaming terminal 101 and used by different client game modules. The general client gaming functions are designed for assisting in implementing and executing a specific game on the client gaming terminal 101 and are available for the client game module 218. These general client gaming functions are, in different embodiments, a selection of a graphical user interface (GUI) 222, a cashbox function 224, a sound function 226, user input interface function, for example buttons 228, data storage 229, a printer 203, a bar code reader 233 and other functions that are related to the performance of a game. The client game module 218 is communicatively coupled to the corresponding server game module 208 for communicating requests 209 and responses 211 in order to utilize the general gaming functions provided in the server. For each game a message protocol for communication between the client module and the server module is generated, the protocol is for example based on XML and is shared by the client 101 and the server 102.

A specific game application program thus comprises a server game module 208 and a client game module 218 that communicate either directly or via an application program interface on the client side and the server side respectively as shown in FIG. 2. The client game module 218 uses a selection of general client gaming functions that are available in the client gaming terminal 101, whereas the server module 208 uses a selection of general server gaming functions 210,212,214,216 that are commonly used by different game applications and that are provided and available centrally in the server 204 in database 210. Further details of a server gaming architecture can be found in WO 2006/052213 and PCT/SE2006/000559, the disclosures of which are incorporated herein by reference.

Establishment of the gaming session involves the gaming server loading the relevant server module, and providing (if necessary) the relevant client module to the client gaming terminal 101.

In the embodiment, there are a plurality of modules provided in the client and the server such that the player can play game and the same time purchase a lottery ticket. That is, during a break in play of a game or while the game doesn't require player interaction such as during a free game feature, the player can purchase a lottery ticket at the terminal 101.

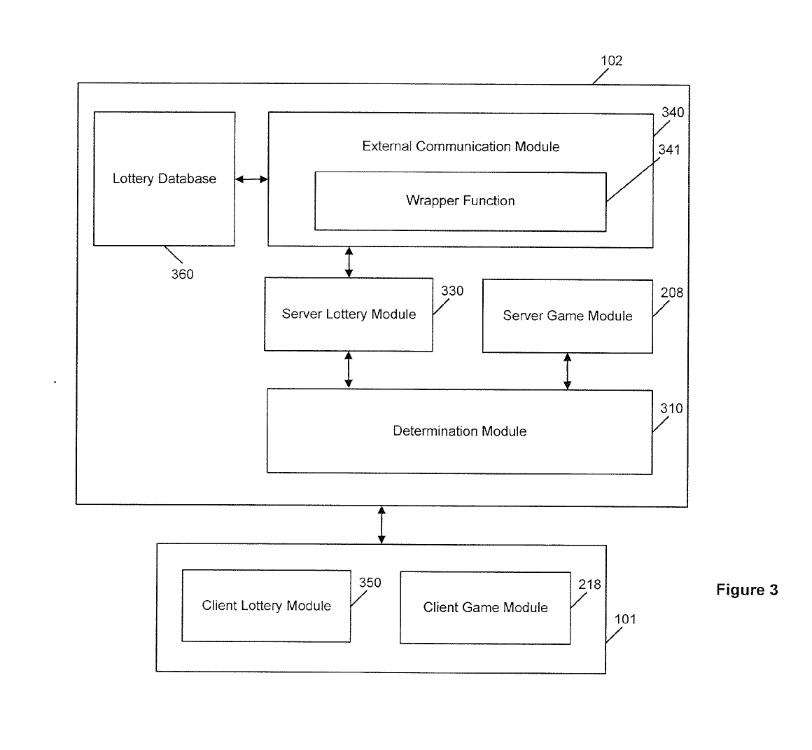

The arrangement is illustrated in FIG. 3 where it will be apparent that the game server which otherwise operates as indicated in FIG. 2 has both a client lottery module 350 and a game module 218. Accordingly, in use, the gaming client 101 is operated by the player to enter instructions for play of the game or to enter instructions for purchase of a lottery ticket. These instructions are formatted and sent to the server as terminal data.

The gaming server is advantageously arranged to determine with determination module 310 whether terminal data it receives contains instructions for either play of a game, in which case the server game module 208, or instructions for entry in a lottery 330, in which case it invokes the lottery module 330. The lottery module 330 formulates the numbers received from the player as part of the terminal data and generates a lottery entry. It then passes this lottery entry to an external communication module 340 which implements a wrapper function, which adds address information and an identifier compatible with the external lottery system before communication with the lottery system 104 over network 103. The external communication module 340 (or the lottery module 330) stores data in the lottery database 360 linking the communication with the external lottery system to make the lottery entry to the lottery terminal for which the lottery entry was generated. The data linking the entry to the terminal can be, for example, a session identifier. This enables the external communication module 360, upon receipt of a receipt generated by the lottery system 104 for the lottery entry, to pass the receipt to the correct terminal where it can be printed by the player.

Persons skilled in the art will appreciate that while in the above described embodiment, there is a single communication between lottery module 330 and the client 350 and the lottery module 330 in the server 330 in order to generate the data for an entry, there may, in practice be multiple communications.

Further, embodiments are envisaged where part of the communication may be to load the lottery module onto the client 101. Still further, it may be the case that only one of the lottery module 330 or the game server module 208 is active within the server 102 at any one time and the determination module 310 determines which of these to activate.

Persons skilled in the art, will appreciate from the above description of the system that the invention may be further embodied as a method. It will be appreciated that at least part of the method will be implemented digitally by a processor. Persons skilled in the art will also appreciate that the method could be implemented by providing program code. The program code could be supplied in a number of ways, for example on a tangible computer readable storage medium, such as a disc or a memory (for example, that could replace part of memory 103) or as a data signal (for example, by transmitting it from a server). Persons skilled in the art, will appreciate that program code provides a series of instructions executable by the processor.

Herein the term “processor” is used to refer generically to any device that can process computer readable instructions and may include: a microprocessor, microcontroller, programmable logic device or other computational device, a general purpose computer (e.g. a PC) or a server. That is a processor may be provided by any suitable logic circuitry for receiving inputs, processing them in accordance with instructions stored in memory and generating outputs (for example on the display). Such processors are sometimes also referred to as central processing units (CPUs). Most processors are general purpose units, however, it is also know to provide a specific purpose processor using an application specific integrated circuit (ASIC) or a field programmable gate array (FPGA).

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A gaming system server, the server arranged to receive terminal data from a player operable terminal and determine whether the terminal data includes at least one of game play data and lottery data, the server comprising:
a game module which operates in response to a determination that the terminal data includes game play data to generate server game data based on the game play data for transmission to the player operable terminal;
a lottery module which operates in response to a determination that the terminal data includes lottery data to generate a lottery entry; and
a communication module arranged to implement a wrapper function to convert the lottery entry into a format compatible with an independent lottery system, the conversion including linking a unique identifier with the lottery entry, the communication module being further arranged to communicate the converted lottery entry and linked unique identifier to the independent lottery system, to receive a receipt containing said unique identifier from the lottery system for the lottery entry, and to forward the receipt to the terminal based on the unique identifier.

2. A gaming system server as claimed in claim 1, wherein the server associates the receipt with a terminal by associating the receipt with a player of the terminal.

3. A gaming system server as claimed in claim 1, comprising a determination module for conducting the determination.

4. A gaming system server as claimed in claim 2, comprising a determination module for conducting the determination.

5. A gaming system server as claimed in claim 4, wherein the determination module selectively activates the lottery module or the game module in dependence on whether game play data or lottery data is included in the terminal data.

6. A gaming system server as claimed in claim 1, arranged to communicate with a plurality of player operable terminals and process terminal data from each player terminal to determine whether the terminal data includes game play data or lottery data.

7. A gaming system server as claimed in claim 1, wherein the server comprises a plurality of computers and the communication module is implemented by a computer which is separate to the computer or computers which implement the game play module and the lottery module.

8. A gaming system server as claimed in claim 1, comprising a processor and a tangible memory accessible by the processor to enable the processor to execute computer program instructions stored therein for the game play module, the lottery module and the communications module.

9. A method in a gaming system, comprising:
receiving terminal data from a player operable terminal at a gaming server and determining whether the terminal data includes at least one of game play data and lottery data, the server comprising:
operating a game module of the game server in response to a determination that the terminal data includes game play data to generate server game data based on the game play data for transmission to the player operable terminal;
operating a lottery module of the game server in response to a determination that the terminal data includes lottery data to generate a lottery entry;
implementing a wrapper function to convert the lottery entry into a format compatible with an independent lottery system, the conversion including linking a unique identifier with the lottery entry, the converted lottery entry and linked unique identifier being communicated to the independent lottery system;
receiving a receipt at the game server containing said unique identifier from the lottery system for the lottery entry; and
forwarding the receipt to the terminal based on the unique identifier.

10. A method as claimed in claim 9, comprising associating the receipt with a terminal by associating the receipt with a player of the terminal.

11. A method as claimed in claim 9, comprising
selectively activating the lottery module or the game module in dependence on whether game play data or lottery data is included in the terminal data.

12. A method as claimed in claim 10, comprising
selectively activating the lottery module or the game module in dependence on whether game play data or lottery data is included in the terminal data.

13. A tangible computer readable storage device or disk comprising the computer program code which, when executed, implements a method in a gaming system, the method comprising:
receiving terminal data from a player operable terminal at a gaming server and determining whether the terminal data includes at least one of game play data and lottery data, the server comprising:
operating a game module of the game server in response to a determination that the terminal data includes game play data to generate server game data based on the game play data for transmission to the player operable terminal;
operating a lottery module of the game server in response to a determination that the terminal data includes lottery data to generate a lottery entry;
implementing a wrapper function to convert the lottery entry into a format compatible with an independent lottery system, the conversion including linking a unique identifier with the lottery entry, the converted lottery entry and linked unique identifier being communicated to the independent lottery system;
receiving a receipt at the game server containing said unique identifier from the lottery system for the lottery entry; and
forwarding the receipt to the terminal based on the unique identifier.

14. A storage device or disk as claimed in claim 13, wherein the method further comprises associating the receipt with a terminal by associating the receipt with a player of the terminal.

15. A storage device or disk as claimed in claim 13, wherein the method further comprises selectively activating the lottery module or the game module in dependence on whether game play data or lottery data is included in the terminal data.

16. A storage device or disk as claimed in claim 14, wherein the method further comprises selectively activating the lottery module or the game module in dependence on whether game play data or lottery data is included in the terminal data.
